(19) United States
(12) Patent Application Publication
(10) Pub. No.: US 2023/0228893 A1
(43) Pub. Date: Jul. 20, 2023

(54) METHOD, DEVICE AND SYSTEM FOR IN-SITU CALIBRATION OF FIXED RADIATION DOSE RATE INSTRUMENT

(71) Applicant: National Institute of Metrology, China, Beijing (CN)

(72) Inventors: Jianwei HUANG, Beijing (CN); Dehong LI, Beijing (CN); Siming GUO, Beijing (CN); Yang YANG, Beijing (CN); Xuan ZHANG, Beijing (CN); Lei CAO, Beijing (CN); Xiaole ZHANG, Beijing (CN)

(21) Appl. No.: 18/071,147

(22) Filed: Nov. 29, 2022

(30) Foreign Application Priority Data
Jan. 17, 2022 (CN) 202210051498.9

(51) Int. Cl. G01T 7/00

(52) U.S. Cl. CPC G01T 7/005

(57) ABSTRACT

A method for in-situ calibration of a fixed radiation dose rate instrument is provided, comprising: in a reference radiation field, calibrating a standard device, a first device to be calibrated to an n^{th} device to be calibrated under a proposed database type, and obtaining a response signal of a first nonhomogeneous extended field generated by a first radiation source, and then establishing a database about type-relative position relationship-statistical data; generating a second nonhomogeneous extended field by a second radiation source with the same type as the first radiation source during in-situ calibration; and searching the type of a current device to be calibrated, and obtaining a final in-situ calibration factor of the current device to be calibrated according to a value in the database corresponding to the type.

### CROSS REFERENCE TO RELATED APPLICATION

This patent application claims the benefit and priority of Chinese Patent Application No. 202210051498.9, entitled “METHOD, DEVICE AND SYSTEM FOR IN-SITU CALIBRATION OF FIXED RADIATION DOSE RATE INSTRUMENT” filed on Jan. 17, 2022, which is incorporated by reference herein in its entirety as part of the present application.

### TECHNICAL FIELD

The present disclosure relates to the technical field of radiation measurement, and in particular, to a method, device and system for in-situ calibration of a fixed radiation dose rate instrument.

### BACKGROUND ART

Environmental radiation refers to the radiation caused by natural gamma radiation, fallout gamma radiation, artificial gamma radiation, cosmic rays, and like. An environmental radiation dose (rate) is an important physical parameter to characterize the level of environmental radiation, which has important reference value for environmental protection and safety protection of nuclear activities.

The existing device for measuring the environmental radiation dose (rate) is mainly a fixed environmental radiation monitoring station including a fixed radiation dose rate instrument. There are two ways to verify and calibrate the fixed radiation dose rate instrument: one way is to send it to a laboratory for calibration, which has a advantage of high calibration accuracy, but this way is restricted by conditions of usage as it must be performed in the laboratory; another way is on-site calibration, which has no effect on continuous monitoring, but it is required to use radiation sources with high activity to establish reference radiation conditions, and thus there are great difficulties for implementing the way.

### SUMMARY

A purpose of the present disclosure is to provide a method, device and system for in-situ calibration of a fixed radiation dose rate instrument, so as to solve the restricted conditions of usage and the difficulties of implementation in the prior art.

In a first aspect, the present disclosure provides a method for in-situ calibration of a fixed radiation dose rate instrument, including:
in a reference radiation field, calibrating a standard device, a first device to be calibrated to an n^{th} device to be calibrated under a proposed database type to obtain a first calibration factor of the standard device, and a first second-calibration factor of the first device to be calibrated up to an n^{th} second-calibration factor of the n^{th} device to be calibrated;
under laboratory background conditions, obtaining a first background response signal of the standard device, a first second- background response signal of the first device to be calibrated up to an n^{th} second- background response signal of the n^{th} device to be calibrated;
generating a first nonhomogeneous extended field by a first radiation source, and fixing the first radiation source, the standard device and the first device to be calibrated as a first relative position relationship to obtain a first response signal of the standard device relative to the first nonhomogeneous extended field and a second response signal of the first device to be calibrated relative to the first nonhomogeneous extended field, under the first relative position relationship;
according to the first calibration factor, the first second-calibration factor, the first background response signal, the second background response signal, the first response signal and the second response signal, calculating a first first-relative response result between the standard device and the first device to be calibrated under the first relative position relationship, up to an m^{th} first-relative response result between the standard device and the first device to be calibrated under an m^{th} relative position relationship;
calculating a first n^{th}-relative response result between the standard device and the n^{th} device to be calibrated under the first relative position relationship up to an m^{th} n^{th}-relative response result between the standard device and the n^{th} device to be calibrated under the m^{th} relative position relationship, and obtaining first statistical data of the proposed database type under the first relative position relationship according to the first first-relative response result to the first n^{th}-relative response result up to m^{th} statistical data of the proposed database type under the m^{th} relative position relationship according to the first n^{th}-relative response result to the m^{th} n^{th}-relative response result;
under in-situ calibration conditions, obtaining a third background response signal of the standard device and a fourth background response signal of a current device to be calibrated, wherein a type of the current device to be calibrated exists in the proposed database type;
generating a second nonhomogeneous extended field by a second radiation source; and fixing the second radiation source, the standard device and the current device to be calibrated as a first relative position relationship to obtain a third response signal of the standard device relative to the second nonhomogeneous extended field and a fourth response signal of the current device to be calibrated relative to the second nonhomogeneous extended field, under the first relative position relationship, wherein the second radiation source and the first radiation source are a same type of radiation source;
according to the first calibration factor, the third background response signal, the fourth background response signal, the third response signal and the fourth response signal under the first relative position relationship, and the first statistical data under the first relative position relationship, calculating a first in-situ calibration factor of the current device to be calibrated under the first relative position relationship, up to an m^{th} in-situ calibration factor of the current device to be calibrated under the m^{th} relative position relationship; and
according to the first in-situ calibration factor to the m^{th} in-situ calibration factor, calculating a final in-situ calibration factor of the current device to be calibrated.

Preferably, obtaining the first calibration factor of the standard device, specifically includes:
obtaining a reference dose at a calibration point in the reference radiation field;
placing an equivalent center of the standard device at the calibration point and measuring a background response result of the standard device under background conditions;
turning on an irradiation device to measure a response value of the standard device; and
determining the first calibration factor according to the reference dose, the background response result and the response value.

Preferably, wherein according to the first calibration factor, the first second-calibration factor, the first background response signal, the second background response signal, the first response signal and the second response signal, calculating the first first-relative response result between the standard device and the first device to be calibrated under the first relative position relationship, specifically includes:
subtracting, from the second response signal under the first relative position relationship, the second background response signal, and then multiplying the first second-calibration factor to obtain a first product;
subtracting, from the first response signal under the first relative position relationship, the first background response signal, and then multiplying the first calibration factor to obtain a second product; and
obtaining the first first-relative response result under the first relative position relationship according to a ratio of the first product to the second product.

Preferably, obtaining the first statistical data of the proposed database type under the first relative position relationship, specifically includes:

dividing, by n, a sum of the first first-relative response result between the standard device and the first device to be calibrated to the first n^{th}-relative response result between the standard device and the n^{th} device to be calibrated, under the first position relationship, to obtain the first statistical data.

Preferably, calculating the first in-situ calibration factor of the current device to be calibrated under the first relative position relationship, specifically includes:
subtracting, from the third response signal under the first relative position relationship, the third background response signal, and then multiplying the first calibration factor to obtain a third product;
subtracting, from the fourth response signal under the first relative position relationship, the fourth background response signal to obtain a first difference; and
dividing, by the first difference, the third product, and then multiplying the first statistical data under the first relative position relationship to obtain the first in-situ calibration factor under the first relative position relationship.

Preferably, according to the first in-situ calibration factor to the m^{th} in-situ calibration factor, calculating the final in-situ calibration factor of the current device to be calibrated, specifically includes:

dividing, by m, a sum of the first in-situ calibration factor to the m^{th} in-situ calibration factor under the m^{th} relative position relationship, to obtain the final in-situ calibration factor of the current device to be calibrated.

Preferably, a number of n is not less than 20.

Preferably, a database is established, including the first statistical data under the first relative position relationship to the m^{th} statistical data under the m^{th} relative position relationship, under the proposed database type.

In a second aspect, the present disclosure provides a device for in-situ calibration of a fixed radiation dose rate instrument, including:
a calibration module, configured to, in a reference radiation field, calibrate a standard device, a first device to be calibrated to an n^{th} device to be calibrated under a proposed database type to obtain a first calibration factor of the standard device, and a first second-calibration factor of the first device to be calibrated up to an n^{th} second-calibration factor of the n^{th} device to be calibrated;
an acquisition module, configured to, under laboratory background conditions, obtain a first background response signal of the standard device, a first second background response signal of the first device to be calibrated up to an n^{th} second background response signal of the n^{th} device to be calibrated;
wherein, the acquisition module is further configured to generate a first nonhomogeneous extended field by a first radiation source, and fix the first radiation source, the standard device and the first device to be calibrated as a first relative position relationship to obtain a first response signal of the standard device relative to the first nonhomogeneous extended field and a second response signal of the first device to be calibrated relative to the first nonhomogeneous extended field, under the first relative position relationship;
a calculation module, configured to, according to the first calibration factor, the first second-calibration factor, the first background response signal, the second background response signal, the first response signal and the second response signal, calculate a first first-relative response result between the standard device and the first device to be calibrated under the first relative position relationship, up to an m^{th} first relative response result between the standard device and the first device to be calibrated under an m^{th} relative position relationship;
wherein, the calculation module is further configured to calculate a first n^{th}-relative response result between the standard device and the n^{th} device to be calibrated under the first relative position relationship up to an m^{th} n^{th}-relative response result between the standard device and the n^{th} device to be calibrated under the m^{th} relative position relationship, and obtain first statistical data of the proposed database type under the first relative position relationship according to the first first-relative response result to the first n^{th}-relative response result up to m^{th} statistical data of the proposed database type under the m^{th} relative position relationship according to the first n^{th}-relative response result to the m^{th} n^{th}-relative response result;
the acquisition module is further configured to obtain a third background response signal of the standard device and a fourth background response signal of a current device to be calibrated in an in-situ calibration condition, wherein the type of the current device to be calibrated exists in the proposed database type;
the acquisition module is further configured to generate a second nonhomogeneous extended field by a second radiation source; and fix the second radiation source, the standard device and the current device to be calibrated as a first relative position relationship to obtain a third response signal of the standard device relative to the second nonhomogeneous extended field and a fourth response signal of the current device to be calibrated relative to the second nonhomogeneous extended field, under the first relative position relationship, wherein the second radiation source and the first radiation source are a same type of radiation source;
the calculation module is further configured to, according to the first calibration factor, the third background response signal, the fourth background response signal, the third response signal and the fourth response signal under the first relative position relationship, and the first statistical data under the first relative position relationship, calculate a first in-situ calibration factor of the current device to be calibrated under the first relative position relationship, up to an m^{th} in-situ calibration factor of the current device to be calibrated under the m^{th} relative position relationship; and
the calculation module is further configured to, according to the first in-situ calibration factor to the m^{th} in-situ calibration factor, calculate a final in-situ calibration factor of the current device to be calibrated.

In a third aspect, the present disclosure provides a chip system for in-situ calibration of a fixed radiation dose rate instrument, including a processor coupled with a memory, where the memory has program instructions stored therein, which are executed by the processor to implement a method for in-situ calibration of a fixed radiation dose rate instrument according to any one of the first aspect.

By applying the in-situ calibration method provided by the present disclosure, the calibration factor is obtained by the reference radiation field, the non-reference radiation field is established based on the nonhomogeneous extended field, and the standard device is scientifically, effectively and reliably correlated with the database, so that during the in-situ calibration, the in-situ calibration of a fixed radiation dose rate instrument is realized, and the execution of the calibration is simple, thereby saving manpower and material resources.

### BRIEF DESCRIPTION OF THE DRAWINGS

FIG. 1 is a schematic flowchart of a method for in-situ calibration of a fixed radiation dose rate instrument according to an embodiment of the present disclosure;

FIG. 2A is a schematic diagram of reference radiation conditions during in-situ calibration in the prior art;

FIG. 2B is a schematic diagram of non-reference radiation conditions during in-situ calibration in an embodiment of the present disclosure;

In FIG. 3, steps 310 to 340 are a method flowchart of the in-situ calibration corresponding to FIG. 2A, and steps 410 to 440 are a method flowchart of the in-situ calibration corresponding to FIG. 2B; and

FIG. 4 is a schematic structural diagram of a device for in-situ calibration of the fixed radiation dose rate instrument according to an embodiment of the present disclosure.

### DETAILED DESCRIPTION OF THE EMBODIMENTS

The present application will be further described in detail below with reference to the accompanying drawings and embodiments. It should be understood that the specific embodiments described herein are only used to explain related disclosures, rather than limit the present disclosure. In addition, it should also be noted that, for the convenience of description, only the parts related to the related disclosures are shown in the drawings.

It should be noted that the embodiments in this application and the features in the embodiments may be combined with each other without conflict. The technical solutions of the present disclosure will be described in further detail below through the accompanying drawings and embodiments.

In this application, a database including various types of devices to be calibrated are first established, so that when the in-situ calibration is performed on the current device to be calibrated, the in-situ calibration factor of the current device to be calibrated can be obtained according to the established database, thereby realizing the in-situ calibration of the fixed radiation dose rate instrument.

### Embodiment 1

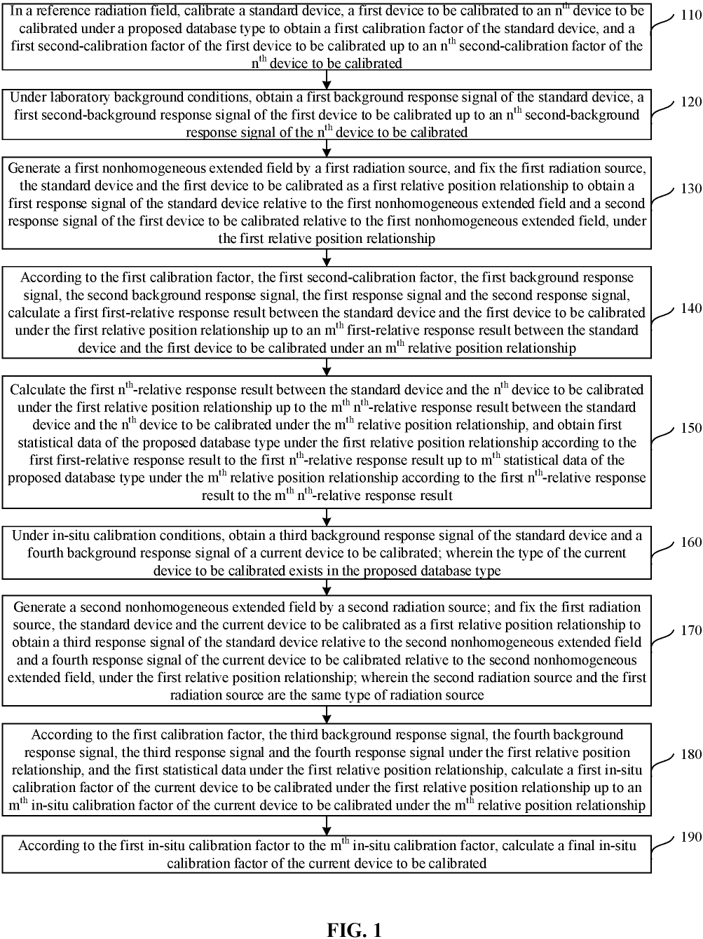

FIG. 1 is a schematic flowchart of a method for in-situ calibration of a fixed radiation dose rate instrument according to an embodiment of the present disclosure. The method can be applied to the in-situ calibration of a dose rate instrument calibrated in a reference radiation field in the field of ionizing radiation. As shown in FIG. 1, the method includes steps 110-190.

Step 110: in the reference radiation field, a standard device, a first device to be calibrated to an n^{th} device to be calibrated under a proposed database type are calibrated, and a first calibration factor of the standard device, and a first second-calibration factor of the first device to be calibrated up to an n^{th} second-calibration factor of the n^{th} device to be calibrated are obtained.

It is specifically described how to obtain the first calibration factor as follows:

First, a reference dose is acquired at a calibration point in the reference radiation field; then, an equivalent center of the standard device is placed at the calibration point, and a background response result of the standard device under background conditions is measured; further, an irradiation device is turned on to measure a response value of the standard device; finally, the first calibration factor is determined according to the reference dose, the background response result and the response value.

Specifically, the standard device is referred as S. A device to be calibrated under the proposed database type is referred as type-i. For example, the first device to be calibrated is type-1, the second device to be calibrated is type-2 ... and the n^{th} device to be calibrated is type-n, where n is an empirical threshold and can be a real number not less than 20, i.e. the number of devices to be calibrated is not less than 20. A reference dose rate of the calibration point is D_{ref}. The equivalent center of the standard device is placed at the calibration point, and the background response result I_{S,bg} of the standard device under background conditions is measured; the irradiation device is turned on to measure the response value I_{S,ref} of the standard device, and a result for the first calibration factor N_{S,ref} of the standard device is:

$${N}_{S , r e f} = \frac{{\dot{D}}_{r e f}}{\left({I}_{S , r e f} - {I}_{S , b g}\right)} .$$

Similarly, the first second calibration factor of the first device to be calibrated under the proposed database type can be obtained by the same calculation manner as that for obtaining the first calibration factor, until the n^{th} second calibration factor of the n^{th} device to be calibrated is obtained.

Step 120: under laboratory background conditions, a first background response signal of the standard device, a first second background response signal of the first device to be calibrated up to an n^{th} second background response signal of the n^{th} device to be calibrated are obtained.

Specifically, under the laboratory background conditions, the equivalent center of the standard device is placed at the calibration point and the first background response signal I_{S,bg} of the standard device under the laboratory background conditions is measured. The equivalent centers of the first device to be calibrated, the second device to be calibrated up to the n^{th} device to be calibrated are successively placed at the calibration point, and the first second background response signal, the second second background response signal up to the n^{th} second background response signal under the laboratory background conditions are measured, each of which can be uniformly referred as I_{type-i,bg}. According to the value of i, I_{type-1,bg} represents the first second background response signal when i is 1, I_{type-2,bg} represents the second second background response signal when i is 2, and I_{type-n,bg} represents the n^{th} second background response signal when i is n.

Step 130: a first nonhomogeneous extended field is generated by a first radiation source; the first radiation source, the standard device and the first device to be calibrated are fixed as a first relative position relationship to obtain a first response signal of the standard device relative to the first nonhomogeneous extended field and a second response signal of the first device to be calibrated relative to the first nonhomogeneous extended field under the first relative position relationship.

Here, in the first relative position relationship, respective distances from the standard device and the first device to be calibrated to the surface of the radiation source are fixed, where the position relationship among the standard device, the first device to be calibrated and the radiation source can be collectively referred as the first relative position relationship under this fixed distances. Correspondingly, an m^{th} relative position relationship is the relative position relationship among the standard device, the first device to be calibrated and the radiation source formed after the change of the respective distances from the standard device and the first device to be calibrated to the radiation source, which is different from the first relative position relationship; where m is an empirical threshold, which can be set according to actual requirements and not limited by this application.

Step 140: according to the first calibration factor, the first second-calibration factor, the first background response signal, the second background response signal, the first response signal and the second response signal, a first first-relative response result between the standard device and the first device to be calibrated under the first relative position relationship is calculated, until an m^{th} first-relative response result between the standard device and the first device to be calibrated under the m^{th} relative position relationship is calculated.

After the first radiation source, the standard device and the i^{th} device to be calibrated type-i are fixed as a relative position relationship posj, the first response signal I_{S,pos_j} of the standard device relative to the first radiation source, the second response signal I_{type-i, pos_j} of the first to n^{th} device to be calibrated relative to the first radiation source can be measured, where according to the value of i, I_{type-i, pos_j} can represent the first second response signal of the first device to be calibrated up to an n^{th} second response signal of the n^{th} device to be calibrated.

Specifically, the first relative response result under the first relative position can be obtained according to the following steps:

A first product is obtained by subtracting the second background response signal from the second response signal under the first relative position relationship and then multiplying the first second-calibration factor.

A second product is obtained by subtracting the first background response signal from the first response signal under the first relative position relationship and then multiplying the first calibration factor.

The first first-relative response result under the first relative position relationship can be obtained according to a ratio of the first product to the second product, which can be specifically expressed as:

$${R}_{t y p e - i , p o s \_ j} = \frac{{N}_{t y p e - i , r e f} \cdot \left({I}_{t y p e - i , p o s \_ j} - {I}_{t y p e - i , b g}\right)}{{N}_{S , r e f} \cdot \left({I}_{S , p o s \_ j} - {I}_{S , b g}\right)} .$$

Here, after the change of the first relative position relationship, a new first relative response result can be obtained each time the relative position relationship is changed. When posj is the first relative position relationship, if i=1, R_{type-i, pos_j} can represent the first first-relative response result of the first device to be calibrated under the first relative position relationship; when posj is the second relative position relationship, if i=1, R_{type-i, pos_j} can represent the second first relative response result of the first device to be calibrated under the second relative position relationship; when pos_j is the m^{th} relative position relationship, if i=1, R_{type-i, pos_j} can represent the m^{th} first relative response result of the first device to be calibrated under the m^{th} relative position relationship; and by parity of reasoning, when pos_j is the first relative position relationship, if i=n, R_{type-i,pos_j} can represent the first first-relative response result of the n^{th} device to be calibrated under the first relative position relationship; when posj is the second relative position relationship, if i=n, R_{type-i, pos_j} can represent the second first relative response result of the n^{th} device to be calibrated under the second relative position relationship; and when pos_j is the m^{th} relative position relationship, if i=n, R_{type-i, pos_j} can represent the m^{th} first relative response result of the n^{th} device to be calibrated under the m^{th} relative position relationship.

It can be understood that, if the m^{th} first relative response result of the n^{th} device to be calibrated under the m^{th} relative position relationship can be obtained, the first response signal and the second response signal in the above formula can be the first response signal and the second response signal of the n^{th} device to be calibrated under the m^{th} relative position relationship.

Step 150: the first n^{th} relative response result between the standard device and the n^{th} device to be calibrated under the first relative position relationship is calculated, until the m^{th} n^{th}-relative response result between the standard device and the n^{th} device to be calibrated under the m^{th} relative position relationship is calculated. According to the first first-relative response result to the first n^{th}-relative response result, first statistical data of the proposed database type under the first relative position relationship is obtained, until according to the first n^{th} relative response result to the m^{th} n^{th} relative response result, m^{th} statistical data of the proposed database type under the m^{th} relative position relationship is obtained.

Where the first statistical data of the proposed database type under the first relative position relationship is obtained, specifically including:

A sum of the first first-relative response result between the standard device and the first device to be calibrated, to the first n^{th}-relative response result between the standard device and the n^{th} device to be calibrated, under the first position relationship, is divided by n to obtain the first statistical data, which can be specifically expressed as:

$${R}_{t y p e , p o s \_ j} = \frac{1}{n} {\sum }_{i = 1}^{n} {R}_{t y p e - i , p o s \_ j} .$$

Here, R_{type,pos_j} represents statistical data under different relative position relationships; when pos_j is the first relative position relationship, R_{type,pos_j} represents the first statistical data under the first relative position relationship; when posj is the second relative position relationship, R_{type,pos_j} represents the second statistical data under the second relative position relationship; and when posj is the m^{th} relative position relationship, R_{type,pos_j} represents the m^{th} statistical data under the m^{th} relative position relationship.

Therefore, the first statistical data can represent an average value for the relative response results of the device to be calibrated of this type under the first relative position relationship. For different types of devices to be calibrated, a database consists of a set of the first statistical data under the first relative position relationship to the m^{th} statistical data under the m^{th} relative position relationship of a device to be calibrated of each type.

As a result, based on the division of types, the database including statistical data of various types of devices to be calibrated under multiple relative position relationships is established. Then, when performing in-situ calibration, it is only necessary to place the current device to be calibrated in the same relative position relationship, and search the statistical data corresponding to this relative position relationship to obtain the in-situ calibration factor of the current device to be calibrated under each relative position relationship.

Step 160: under in-situ calibration conditions, a third background response signal of the standard device and a fourth background response signal of the current device to be calibrated are obtained; where the type of the current device to be calibrated exists in the proposed database type.

Specifically, the current device to be calibrated is the device currently to be calibrated, and the third background response signal of the standard device and the fourth background response signal of the current device to be calibrated can be obtained in the same manner as step 120. Where the standard device is expressed as S, the current device to be calibrated is expressed as type-C, the third background response signal can be expressed as I_{S, BG}, and the fourth background response signal can be expressed as I_{type-C, BG}.

Step 170: a second nonhomogeneous extended field is generated by a second radiation source; the second radiation source, the standard device and the current device to be calibrated are fixed as the first relative position relationship to obtain a third response signal of the standard device relative to the second nonhomogeneous extended field and a fourth response signal of the current device to be calibrated relative to the second nonhomogeneous extended field, under the first relative position relationship; where the second radiation source and the first radiation source are the same type of radiation source.

Here, a nonhomogeneous extended field is generated by the second radiation source which is the same type as the first radiation source, to realize the in-situ calibration of the current device to be calibrated. Therefore, through the establishment of the database, the in-situ calibration can be achieved using the same type of radiation sources in the form of “standard device + response database + non-reference radiation field”, thereby solving the problem that the “same” radiation source/“same” reference radiation field must be used for the dissemination of value of quantity, as long as the second radiation source used in the in-situ calibration is the same type as the first radiation source used for the establishment of the database.

Therefore, the corresponding statistical data can be obtained by searching the database, thereby solving the problem that the statistical data of the device to be calibrated cannot be obtained.

Under the same relative position relationship as in step 130, the third response signal I_{S,pos_j, in-situ} and the fourth response signal I_{type-C,pos_j,in-situ} are obtained. Similar to step 130, when the relative position relationship is changed, the third response signal and the fourth response signal corresponding to the corresponding relative position relationship can be obtained. For example, a third response signal and a fourth response signal under the first relative position relationship up to a third response signal and a fourth response signal under the m^{th} relative position relationship can be obtained.

Step 180: according to the first calibration factor, the third background response signal, the fourth background response signal, the third response signal and the fourth response signal under the first relative position relationship, and the first statistical data under the first relative position relationship, a first in-situ calibration factor of the current device to be calibrated under the first relative position relationship, up to an m^{th} in-situ calibration factor of the current device to be calibrated under the m^{th} relative position relationship are calculated.

Here, calculating the first in-situ calibration factor of the current device to be calibrated under the first relative position relationship specifically includes:

Obtaining a third product by subtracting the third background response signal from the third response signal under the first relative position relationship and then multiplying the first calibration factor;

Obtaining a first difference by subtracting the fourth background response signal from the fourth response signal under the first relative position relationship; and

Dividing the third product by the first difference, and then multiplying the first statistical data under the first relative position relationship to obtain the first in-situ calibration factor under the first relative position relationship, which can be specifically expressed as:

$${N}_{t y p e - C , p o s \_ j , i n - s i t u} = \frac{{N}_{S , r e f} \cdot \left({I}_{S , p o s \_ j , i n - s i t u} - {I}_{S , B G}\right)}{\left({I}_{t y p e - C , p o s \_ j , i n - s i t u} - {I}_{t y p e - C , B G}\right)} \cdot {R}_{t y p e , p o s \_ j} .$$

Here N_{type-C, pos_j, in-situ} represents a corresponding in-situ calibration factor under different relative position relationships. For example, when posj represents the first relative position relationship, I_{S, pos_j, in-situ} represents the third response signal under the first relative position relationship, I_{type-C,pos_j,in-situ} represents the fourth response signal under the first relative position relationship, and R_{type,pos_j} represents the statistical data under the first relative position relationship, i.e., the first statistical data.

For the first in-situ calibration factor under the first position relationship, R_{type,pos_j} represents the statistical data under different relative position relationships. Therefore, the current device to be calibrated is placed in sequence under the first relative position relationship to the m^{th} relative position relationship in the database, and the corresponding response signal is measured. According to the type of the current device to be calibrated, it is only necessary to search the database to obtain the corresponding statistical data, so as to obtain the in-situ calibration factor, which realizes the calculation speed of the in-situ calibration factor.

It can be understood that the in-situ calibration factor corresponding to each of the m relative position relationships can be obtained according to step 180, the calculation of which is the same as that for the first in-situ calibration factor under the first relative position, and will not be repeated here.

Step 190: according to the first in-situ calibration factor to the m^{th} in-situ calibration factor, a final in-situ calibration factor of the current device to be calibrated is obtained.

Here a sum of the first in-situ calibration factor to the m^{th} in-situ calibration factor under the m^{th} relative position relationship, is divided by m to obtain the final in-situ calibration factor of the current device to be calibrated, which can be specifically expressed as:

$${N}_{t y p e - C , i n - s i t u} = \frac{1}{m} {\sum }_{j = 1}^{m} {N}_{t y p e - C , p o s \_ j , i n - s i t u ,}$$

Where N_{type-C, in-situ} is the final in-situ calibration factor of the current device to be calibrated, and m represents the number of the relative position relationships.

In the in-situ calibration, instead of the “reference radiation field + standard device” in the laboratory calibration experiment as a carrier and manner, the value of quantity (response) is in the form of “standard device + response database + non-reference radiation field” as the carrier and manner, thereby solving the problem for the in-situ calibration of the fixed device to be calibrated.

It can be understood that the present application is also appropriate for non-ionizing radiation, for example, the in-situ calibration of instruments that require to be calibrated in a reference radiation field in the fields of acoustics, optics, and electromagnetism.

By applying the in-situ calibration method provided by the present disclosure, the calibration factor is obtained by the reference radiation field, the non-reference radiation field is established based on the nonhomogeneous extended field, and the standard device is scientifically, effectively and reliably correlated with the database, so that the during the in-situ calibration, the in-situ calibration of a fixed radiation dose rate instrument is realized, and the execution of the calibration is simple, thereby saving manpower and material resources.

### Embodiment 2

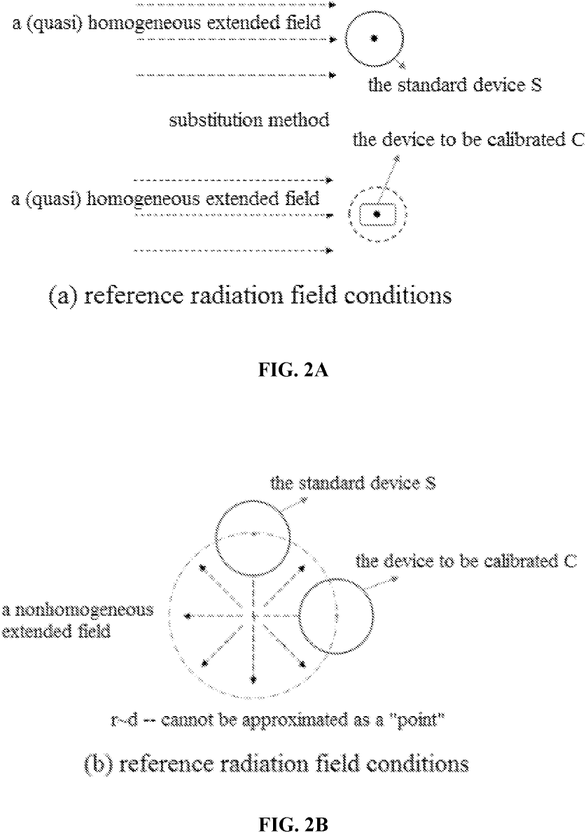

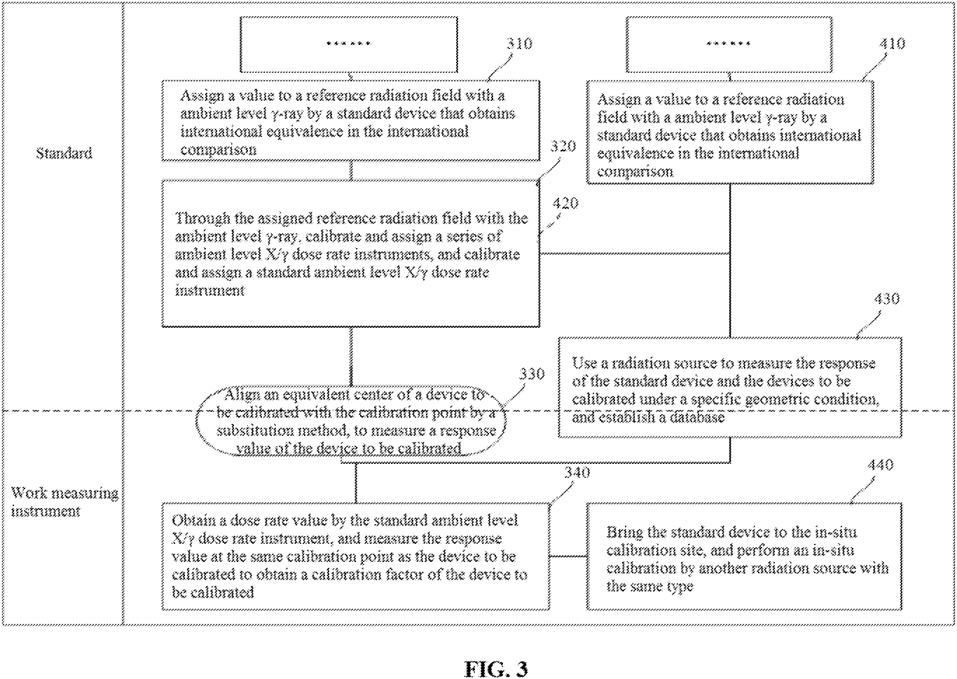

In the prior art, the in-situ calibration is performed, as shown in FIG. 2A and FIG. 3:
Step 310: a standard device that obtains international equivalence in the international comparison assigns a value to a reference radiation field with a ambient level γ -ray;
Step 320: through the assigned reference radiation field with the ambient level γ -ray, a series of ambient level X/ γ dose rate instruments are calibrated and assigned, and a standard ambient level X/ γ dose rate instrument is calibrated and assigned;
Step 330: an equivalent center of a device to be calibrated is aligned with a calibration point by a substitution method, to measure a response value of the device to be calibrated,
where the substitution herein refers to replacing some of the ambient level X/ γ dose rate instruments with the device to be calibrated to measure the response value of the device to be calibrated; and
Step 340: a dose rate value Ḋ_{ref} is obtained by the standard ambient level X/ γ dose rate instrument, and the response value I_{to_cal} is measured at the same calibration point as the device to be calibrated, a calibration factor N_{C,ref} of the device to be calibrated is obtained by the following formula:
$${N}_{C , r e f} = \frac{{\dot{D}}_{r e f}}{{I}_{t o \_ c a l}} .$$

In this application, referring to FIG. 2B, a non-reference radiation condition (i.e., the first nonhomogeneous extended field generated by a first radiation source) is constructed by introducing the first radiation source, so as to establish a database, so that a new calibration route is established. As shown in FIG. 3, an actual calibration applying the improved in-situ calibration method provided by the present application includes Steps 410-440:
Step 410: a standard device that obtains international equivalence in the international comparison assigns a value to a reference radiation field with a ambient level γ -ray,
where this step can obtain the reference radiation field.
Step 420: through the assigned reference radiation field with the ambient level γ -ray, the standard device and a series of devices to be calibrated are calibrated and assigned,
where the series of devices to be calibrated herein are equivalent to the first device to be calibrated to the n^{th} device to be calibrated in step 110, the calibration herein is to obtain the first calibration factor and a series of the second calibration factors, and the assignment is to measure the background response signal and the response signal thereof, which can be performed by referring to step 120 and step 130.

Step 430: a radiation source is used to measure the response of the standard device and the devices to be calibrated under a specific geometric condition, and establish a database.

Here the radiation source herein is equivalent to the first radiation source in step 130, and the database can be established subsequently, and the database can store device types, various relative position relationships, and statistical data under various relative position relationships.

Step 440: the standard device is brought to the in-situ calibration site, and the in-situ calibration is performed by another radiation source with the same type.

Here the specific steps may refer to step 160 - step 190. Therefore, after the establishment of the database, the in-situ calibration can be performed on the device to be calibrated at the in-situ calibration site to obtain the final in-situ calibration factor of the current device to be calibrated, which improves the calibration speed and saves labor and time costs.

### Embodiment 3

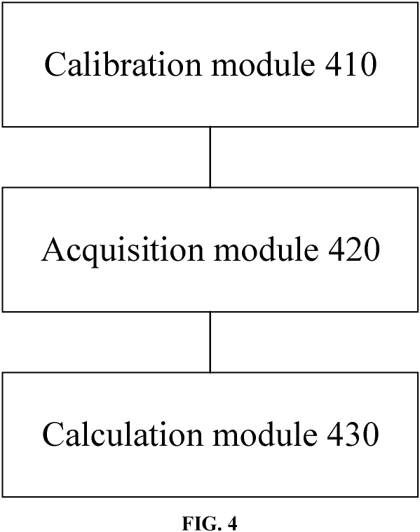

FIG. 4 is a schematic structural diagram of a device for in-situ calibration of the fixed radiation dose rate instrument according to an embodiment of the present disclosure. As shown in FIG. 4, the device for in-situ calibration of the fixed radiation dose rate instrument is applied to the method for in-situ calibration of the fixed radiation dose rate instrument, and the device includes: a calibration module 410, an acquisition module 420 and a calculation module 430.

The calibration module 410 is configured to, in a reference radiation field, calibrate a standard device, a first device to be calibrated to an n^{th} device to be calibrated under a proposed database type to obtain a first calibration factor of the standard device, and a first second calibration factor of the first device to be calibrated up to an n^{th} second calibration factor of the n^{th} device to be calibrated;

The acquisition module 420 is configured to, under laboratory background conditions, obtain a first background response signal of the standard device, a first second background response signal of the first device to be calibrated up to an n^{th} second background response signal of the n^{th} device to be calibrated.

The acquisition module 420 is further configured to generate a first nonhomogeneous extended field by a first radiation source, and fix the first radiation source, the standard device and the first device to be calibrated as a first relative position relationship to obtain a first response signal of the standard device relative to the first nonhomogeneous extended field and a second response signal of the first device to be calibrated relative to the first nonhomogeneous extended field, under the first relative position relationship.

The calculation module 430 is configured to, according to the first calibration factor, the first second calibration factor, the first background response signal, the second background response signal, the first response signal and the second response signal, calculate a first first relative response result between the standard device and the first device to be calibrated under the first relative position relationship up to an m^{th} first relative response result between the standard device and the first device to be calibrated under an m^{th} relative position relationship.

The calculation module 430 is further configured to calculate a first n^{th} relative response result between the standard device and the n^{th} device to be calibrated under the first relative position relationship, up to an m^{th} n^{th}- relative response result between the standard device and the n^{th} device to be calibrated under the m^{th} relative position relationship, and obtain first statistical data of the proposed database type under the first relative position relationship according to the first first- relative response result to the first n^{th}- relative response result, up to m^{th} statistical data of the proposed database type under the m^{th} relative position relationship according to the first n^{th}- relative response result to the m^{th} n^{th}- relative response result.

The acquisition module 420 is further configured to obtain a third background response signal of the standard device and a fourth background response signal of a current device to be calibrated, where the type of the current device to be calibrated exists in the proposed database type.

The acquisition module 420 is further configured to generate a second nonhomogeneous extended field by a second radiation source; and fix the second radiation source, the standard device and the current device to be calibrated as a first relative position relationship to obtain a third response signal of the standard device relative to the second nonhomogeneous extended field and a fourth response signal of the current device to be calibrated relative to the second nonhomogeneous extended field, under the first relative position relationship, where the second radiation source and the first radiation source are the same type of radiation source.

The calculation module 430 is further configured to, according to the first calibration factor, the third background response signal, the fourth background response signal, the third response signal and the fourth response signal under the first relative position relationship, and the first statistical data under the first relative position relationship, calculate a first in-situ calibration factor of the current device to be calibrated under the first relative position relationship up to an m^{th} in-situ calibration factor of the current device to be calibrated under the m^{th} relative position relationship.

The calculation module 430 is further configured to, according to the first in-situ calibration factor to the m^{th} in-situ calibration factor, calculate a final in-situ calibration factor of the current device to be calibrated.

The device provided by this embodiment of the present disclosure can execute the method steps in the above-mentioned embodiment 1, and the implementation principle and technical effect thereof are similar to the embodiment 1 and thus are not repeated here.

It should be understood that the division of individual modules of the device is only a division of logical functions, and these modules can be fully or partially integrated into a physical entity when actually implemented, or they can be physically separated. These modules can all be implemented by invoking software by processing elements; they can also all be implemented as hardware; or some of these modules can be implemented by invoking software by processing elements, and some can be implemented as hardware. For example, the determination module can be a processing element established separately, or can be integrated into a certain chip of the above-mentioned device for implementation. In addition, the function of the determination module can be implemented by a certain processing element of the above-mentioned device invoking program codes stored in a memory of the above-mentioned device. The implementation of other modules is similar to the determination module. Furthermore, all or portion of these modules can be integrated together or implemented independently. The processing element described herein may be an integrated circuit with signal processing capabilities. In the implementation process, each step of the above-mentioned method or each of the above-mentioned modules can be implemented by an integrated logic circuit of hardware in the processing element or instructions in the form of software.

For example, the above-mentioned modules may be one or more integrated circuits configured to implement the above-mentioned method, such as one or more specific integrated circuits (Application Specific Integrated Circuit, ASIC), or one or more microprocessors (Digital Signal Processor, DSP), or, one or more field programmable gate arrays (FPGA), etc. For another example, when one of the above-mentioned modules is implemented by a processing element invoking program codes, the processing element may be a general-purpose processor, such as a central processing unit (CPU) or other processors that can invoke program codes. For another example, these modules can be integrated together and implemented in the form of a System-on-a-Chip (SOC).

In the above embodiment, it may be implemented in whole or part by software, hardware, firmware, or any combination thereof. When implemented by software, it may be implemented in whole or part in the form of a computer program product. The computer program product includes one or more computer instructions. When the one or more computer instructions are loaded and executed on a computer, the processes or function described according to the embodiments of the present application are generated in whole or part. The computer may be a general-purpose computer, a special purpose computer, a computer network, or other programmable device. The computer instructions may be stored in a computer readable storage medium, or transmitted from a computer readable storage medium to another computer readable storage medium, for example, the computer instructions may be transmitted from a website site, computer, server, or data center to another website site, computer, server or data center via wire communication (e.g. coaxial cable, optical fiber, Digital Subscriber Line (DSL)) or wireless communication (e.g. infrared, wireless, Bluetooth, microwave, etc.). The computer readable storage medium can be any available medium that the computer can access or a data storage device, such as a server, a data center, etc., that includes one or more available mediums. The available medium may be magnetic medium (e.g., floppy disk, hard disk, magnetic tape), optical medium (e.g., DVD), or semiconductor medium (e.g., solid state disk (SSD)), and the like.

### Embodiment 4

The present embodiment provides a chip system for in-situ calibration of a fixed radiation dose rate instrument, including a processor coupled with a memory, the memory has program instructions stored therein, and the program instructions are performed by the processor to implement the method for in-situ calibration of the fixed radiation dose rate instrument provided by Embodiment 1.

Professionals should be further aware that units and algorithm steps of individual examples described in the embodiments disclosed herein can be implemented by electronic hardware, computer software, or a combination of both. In order to clearly illustrate the interchangeability between hardware and software, the components and steps of individual examples have been generally described in terms of functions in the above description. It depends on the specific application and design constraints of the technical solution that whether these functions are performed in the form of hardware or software. Professionals may implement the described functions using different methods for each particular application, but such the implementation should not be considered beyond the scope of the present disclosure.

The steps of the method or algorithm described in the embodiments disclosed herein may be implemented by hardware, software module executed by a terminal, or a combination of both. The software module can be placed in a storage medium, such as random access memory (RAM), internal memory, read only memory (ROM), electrically programmable ROM, electrically erasable programmable ROM, register, hard disk, removable disk, CD-ROM, or any other form of storage medium known in the art.

The above specific embodiments further describe the purpose, technical solutions and beneficial effects of the present disclosure in detail. It should be understood that the above embodiments are only specific implementations of the present disclosure, and are not intended to limit the protection scope of the present disclosure. Any modification, equivalent replacement or improvement within the spirit and principle of the disclosure should be included in the protection scope of the disclosure.

What is claimed is:

1. A method for in-situ calibration of a fixed radiation dose rate instrument, comprising:
in a reference radiation field, calibrating a standard device, a first device to be calibrated to an n^{th} device to be calibrated under a proposed database type to obtain a first calibration factor of the standard device, and a first second-calibration factor of the first device to be calibrated up to an n^{th} second-calibration factor of the n^{th} device to be calibrated;
under laboratory background conditions, obtaining a first background response signal of the standard device, a first second-background response signal of the first device to be calibrated up to an n^{th} second-background response signal of the n^{th} device to be calibrated;
generating a first nonhomogeneous extended field by a first radiation source, and fixing the first radiation source, the standard device and the first device to be calibrated as a first relative position relationship to obtain a first response signal of the standard device relative to the first nonhomogeneous extended field and a second response signal of the first device to be calibrated relative to the first nonhomogeneous extended field, under the first relative position relationship;
according to the first calibration factor, the first second-calibration factor, the first background response signal, the second background response signal, the first response signal and the second response signal, calculating a first first-relative response result between the standard device and the first device to be calibrated under the first relative position relationship up to an m^{th} first-relative response result between the standard device and the first device to be calibrated under an m^{th} relative position relationship;
calculating a first n^{th}-relative response result between the standard device and the n^{th} device to be calibrated under the first relative position relationship up to an m^{th} n^{th}-relative response result between the standard device and the n^{th} device to be calibrated under the m^{th} relative position relationship, and obtaining first statistical data of the proposed database type under the first relative position relationship according to the first first-relative response result to the first n^{th}-relative response result up to m^{th} statistical data of the proposed database type under the m^{th} relative position relationship according to the first n^{th}-relative response result to the m^{th} n^{th}-relative response result;
under in-situ calibration conditions, obtaining a third background response signal of the standard device and a fourth background response signal of a current device to be calibrated, wherein a type of the current device to be calibrated exists in the proposed database type;
generating a second nonhomogeneous extended field by a second radiation source; and fixing the second radiation source, the standard device and the current device to be calibrated as a first relative position relationship to obtain a third response signal of the standard device relative to the second nonhomogeneous extended field and a fourth response signal of the current device to be calibrated relative to the second nonhomogeneous extended field, under the first relative position relationship, wherein the second radiation source and the first radiation source are a same type of radiation source;
according to the first calibration factor, the third background response signal, the fourth background response signal, the third response signal and the fourth response signal under the first relative position relationship, and the first statistical data under the first relative position relationship, calculating a first in-situ calibration factor of the current device to be calibrated under the first relative position relationship up to an m^{th} in-situ calibration factor of the current device to be calibrated under the m^{th} relative position relationship; and
according to the first in-situ calibration factor to the m^{th} in-situ calibration factor, calculating a final in-situ calibration factor of the current device to be calibrated.

2. The method according to claim 1, wherein obtaining the first calibration factor of the standard device comprises:
obtaining a reference dose at a calibration point in the reference radiation field;
placing an equivalent center of the standard device at the calibration point and measuring a background response result of the standard device under background conditions;
turning on an irradiation device to measure a response value of the standard device; and
determining the first calibration factor according to the reference dose, the background response result and the response value.

3. The method according to claim 1, wherein according to the first calibration factor, the first second-calibration factor, the first background response signal, the second background response signal, the first response signal and the second response signal, calculating the first first-relative response result between the standard device and the first device to be calibrated under the first relative position relationship, comprises:
subtracting, from the second response signal under the first relative position relationship, the second background response signal, and then multiplying the first second-calibration factor to obtain a first product;
subtracting, from the first response signal under the first relative position relationship, the first background response signal, and then multiplying the first calibration factor to obtain a second product; and
obtaining the first first-relative response result under the first relative position relationship according to a ratio of the first product to the second product.

4. The method according to claim 1, wherein obtaining the first statistical data of the proposed database type under the first relative position relationship, comprises:
dividing, by n, a sum of the first first-relative response result between the standard device and the first device to be calibrated to the first n^{th}-relative response result between the standard device and the n^{th} device to be calibrated, under the first position relationship, to obtain the first statistical data.

5. The method according to claim 1, wherein calculating the first in-situ calibration factor of the current device to be calibrated under the first relative position relationship, comprises:
subtracting, from the third response signal under the first relative position relationship, the third background response signal, and then multiplying the first calibration factor to obtain a third product;
subtracting, from the fourth response signal under the first relative position relationship, the fourth background response signal to obtain a first difference; and
dividing, by the first difference, the third product, and then multiplying the first statistical data under the first relative position relationship to obtain the first in-situ calibration factor under the first relative position relationship.

6. The method according to claim 1, wherein according to the first in-situ calibration factor to the m^{th} in-situ calibration factor, calculating the final in-situ calibration factor of the current device to be calibrated, comprises:
dividing, by m, a sum of the first in-situ calibration factor to the m^{th} in-situ calibration factor under the m^{th} relative position relationship, to obtain the final in-situ calibration factor of the current device to be calibrated.

7. The method according to claim 1, wherein a number of n is not less than 20.

8. The method according to claim 1, wherein a database is established, including the first statistical data under the first relative position relationship to the m^{th} statistical data under the m^{th} relative position relationship, under the proposed database type.

9. A device for in-situ calibration of a fixed radiation dose rate instrument, comprising:
a calibration module, configured to, in a reference radiation field, calibrate a standard device, a first device to be calibrated to an n^{th} device to be calibrated under a proposed database type to obtain a first calibration factor of the standard device, and a first second-calibration factor of the first device to be calibrated up to an n^{th} second-calibration factor of the n^{th} device to be calibrated;
an acquisition module, configured to, under laboratory background conditions, obtain a first background response signal of the standard device, a first second-background response signal of the first device to be calibrated up to an n^{th} second-background response signal of the n^{th} device to be calibrated; wherein, the acquisition module is further configured to generate a first nonhomogeneous extended field by a first radiation source, and fix the first radiation source, the standard device and the first device to be calibrated as a first relative position relationship to obtain a first response signal of the standard device relative to the first nonhomogeneous extended field and a second response signal of the first device to be calibrated relative to the first nonhomogeneous extended field, under the first relative position relationship;
a calculation module, configured to, according to the first calibration factor, the first second-calibration factor, the first background response signal, the second background response signal, the first response signal and the second response signal, calculate a first first-relative response result between the standard device and the first device to be calibrated under the first relative position relationship up to an m^{th} first-relative response result between the standard device and the first device to be calibrated under an m^{th} relative position relationship; wherein, the calculation module is further configured to calculate a first n^{th}-relative response result between the standard device and the n^{th} device to be calibrated under the first relative position relationship up to an m^{th} n^{th}-relative response result between the standard device and the n^{th} device to be calibrated under the m^{th} relative position relationship, and obtain first statistical data of the proposed database type under the first relative position relationship according to the first first-relative response result to the first n^{th}-relative response result up to m^{th} statistical data of the proposed database type under the m^{th} relative position relationship according to the first n^{th}-relative response result to the m^{th} n^{th}-relative response result;
the acquisition module is further configured to obtain a third background response signal of the standard device and a fourth background response signal of a current device to be calibrated in an in-situ calibration condition, wherein the type of the current device to be calibrated exists in the proposed database type;
the acquisition module is further configured to generate a second nonhomogeneous extended field by a second radiation source; and fix the second radiation source, the standard device and the current device to be calibrated as a first relative position relationship to obtain a third response signal of the standard device relative to the second nonhomogeneous extended field and a fourth response signal of the current device to be calibrated relative to the second nonhomogeneous extended field, under the first relative position relationship, wherein the second radiation source and the first radiation source are a same type of radiation source;
the calculation module is further configured to, according to the first calibration factor, the third background response signal, the fourth background response signal, the third response signal and the fourth response signal under the first relative position relationship, and the first statistical data under the first relative position relationship, calculate a first in-situ calibration factor of the current device to be calibrated under the first relative position relationship up to an m^{th} in-situ calibration factor of the current device to be calibrated under the m^{th} relative position relationship; and
the calculation module is further configured to, according to the first in-situ calibration factor to the m^{th} in-situ calibration factor, calculate a final in-situ calibration factor of the current device to be calibrated.

10. A chip system for in-situ calibration of a fixed radiation dose rate instrument, comprising:
a processor coupled with a memory, wherein the memory has program instructions stored therein, which are executed by the processor to implement a method for in-situ calibration of a fixed radiation dose rate instrument;
wherein the method comprises:
in a reference radiation field, calibrating a standard device, a first device to be calibrated to an n^{th} device to be calibrated under a proposed database type to obtain a first calibration factor of the standard device, and a first second-calibration factor of the first device to be calibrated up to an n^{th} second-calibration factor of the n^{th} device to be calibrated;
under laboratory background conditions, obtaining a first background response signal of the standard device, a first second-background response signal of the first device to be calibrated up to an n^{th} second-background response signal of the n^{th} device to be calibrated;
generating a first nonhomogeneous extended field by a first radiation source, and fixing the first radiation source, the standard device and the first device to be calibrated as a first relative position relationship to obtain a first response signal of the standard device relative to the first nonhomogeneous extended field and a second response signal of the first device to be calibrated relative to the first nonhomogeneous extended field, under the first relative position relationship;
according to the first calibration factor, the first second-calibration factor, the first background response signal, the second background response signal, the first response signal and the second response signal, calculating a first first-relative response result between the standard device and the first device to be calibrated under the first relative position relationship up to an m^{th} first-relative response result between the standard device and the first device to be calibrated under an m^{th} relative position relationship;
calculating a first n^{th}-relative response result between the standard device and the n^{th} device to be calibrated under the first relative position relationship up to an m^{th} n^{th}-relative response result between the standard device and the n^{th} device to be calibrated under the m^{th} relative position relationship, and obtaining first statistical data of the proposed database type under the first relative position relationship according to the first first-relative response result to the first n^{th}-relative response result up to m^{th} statistical data of the proposed database type under the m^{th} relative position relationship according to the first n^{th}-relative response result to the m^{th} n^{th}-relative response result;
under in-situ calibration conditions, obtaining a third background response signal of the standard device and a fourth background response signal of a current device to be calibrated, wherein a type of the current device to be calibrated exists in the proposed database type;
generating a second nonhomogeneous extended field by a second radiation source; and fixing the second radiation source, the standard device and the current device to be calibrated as a first relative position relationship to obtain a third response signal of the standard device relative to the second nonhomogeneous extended field and a fourth response signal of the current device to be calibrated relative to the second nonhomogeneous extended field, under the first relative position relationship, wherein the second radiation source and the first radiation source are a same type of radiation source;
according to the first calibration factor, the third background response signal, the fourth background response signal, the third response signal and the fourth response signal under the first relative position relationship, and the first statistical data under the first relative position relationship, calculating a first in-situ calibration factor of the current device to be calibrated under the first relative position relationship up to an m^{th} in-situ calibration factor of the current device to be calibrated under the m^{th} relative position relationship; and
according to the first in-situ calibration factor to the m^{th} in-situ calibration factor, calculating a final in-situ calibration factor of the current device to be calibrated.

11. The chip system according to claim 10, wherein obtaining the first calibration factor of the standard device comprises:
obtaining a reference dose at a calibration point in the reference radiation field;
placing an equivalent center of the standard device at the calibration point and measuring a background response result of the standard device under background conditions;
turning on an irradiation device to measure a response value of the standard device; and
determining the first calibration factor according to the reference dose, the background response result and the response value.

12. The chip system according to claim 10, wherein according to the first calibration factor, the first second-calibration factor, the first background response signal, the second background response signal, the first response signal and the second response signal, calculating the first first-relative response result between the standard device and the first device to be calibrated under the first relative position relationship, comprises:
subtracting, from the second response signal under the first relative position relationship, the second background response signal, and then multiplying the first second-calibration factor to obtain a first product;
subtracting, from the first response signal under the first relative position relationship, the first background response signal, and then multiplying the first calibration factor to obtain a second product; and
obtaining the first first-relative response result under the first relative position relationship according to a ratio of the first product to the second product.

13. The chip system according to claim 10, wherein obtaining the first statistical data of the proposed database type under the first relative position relationship, comprises:
dividing, by n, a sum of the first first-relative response result between the standard device and the first device to be calibrated to the first n^{th}-relative response result between the standard device and the n^{th} device to be calibrated, under the first position relationship, to obtain the first statistical data.

14. The chip system according to claim 10, wherein calculating the first in-situ calibration factor of the current device to be calibrated under the first relative position relationship, comprises:
subtracting, from the third response signal under the first relative position relationship, the third background response signal, and then multiplying the first calibration factor to obtain a third product;
subtracting, from the fourth response signal under the first relative position relationship, the fourth background response signal to obtain a first difference; and
dividing, by the first difference, the third product, and then multiplying the first statistical data under the first relative position relationship to obtain the first in-situ calibration factor under the first relative position relationship.

15. The chip system according to claim 10, wherein according to the first in-situ calibration factor to the m^{th} in-situ calibration factor, calculating the final in-situ calibration factor of the current device to be calibrated, comprises:
dividing, by m, a sum of the first in-situ calibration factor to the m^{th} in-situ calibration factor under the m^{th} relative position relationship, to obtain the final in-situ calibration factor of the current device to be calibrated.

16. The chip system according to claim 10, wherein a number of n is not less than 20.

17. The chip system according to claim 10, wherein a database is established, including the first statistical data under the first relative position relationship to the m^{th} statistical data under the m^{th} relative position relationship, under the proposed database type.
